(19) United States
(12) Patent Application Publication
(10) Pub. No.: US 2012/0229352 A1
(43) Pub. Date: Sep. 13, 2012

(54) ANTENNA MODULE AND PORTABLE ELECTRONIC DEVICE EMPLOYING THE SAME

(75) Inventor: MING-CHUN HSIUNG, Shindian (TW)

(73) Assignee: FIH (HONG KONG) LIMITED, Kowloon (HK)

(21) Appl. No.: 13/104,216

(22) Filed: May 10, 2011

(30) Foreign Application Priority Data
Mar. 11, 2011 (CN) 201110058900.8

(51) Int. Cl. H01Q 1/24

(52) U.S. Cl. 343/702

(57) ABSTRACT

A portable electronic device includes a housing, a circuit board, a number of fasteners and an antenna module. The circuit board is received within the housing and defines a number of through holes corresponding to the fasteners. The antenna module includes a base body defining tow mounting holes and an antenna. The fasteners are inserted and extend through the corresponding mounting holes, and are screwed into the corresponding through holes in turn, and are screwed in the housing, the base body and the circuit board are detachably assembled to each other and the housing together, and the circuit board is non-fixed electrically connected to the antenna.

### BACKGROUND

1. Technical field

The disclosure generally relates to electronic devices, and more particularly to an antenna module and a portable electronic device employing the antenna module.

2. Description of the Related Art

Many portable electronic devices, such as mobile phones and personal digital assistants, include a housing, a motherboard located within the housing, and an antenna. The antenna is electrically connected to the motherboard, and is generally installed on the housing by surface mounted technology (SMT), which is complicated and costly. Moreover, since the antenna is fixed on the housing by SMT, it is difficult to repair or replace.

Therefore, there is room for improvement within the art.

### BRIEF DESCRIPTION OF THE DRAWINGS

Many aspects of an exemplary antenna module and portable electronic device employing the same can be better understood with reference to the following drawings. The components in the drawings are not necessarily drawn to scale, the emphasis instead being placed upon clearly illustrating the principles of the exemplary antenna module and portable electronic device. Moreover, in the drawings, like reference numerals designate corresponding parts throughout the several views. Wherever possible, the same reference numbers are used throughout the drawings to refer to the same or like elements of an embodiment.

FIG. 1 is a schematic and exploded view of a portable electronic device having an antenna module, according to an exemplary embodiment of the disclosure.

FIG. 2 is a schematic and assembled view of the portable electronic device shown in FIG. 1 of the disclosure.

FIG. 3 is a partial assembled view of the portable electronic device shown in FIG. 2 of the disclosure.

### DETAILED DESCRIPTION

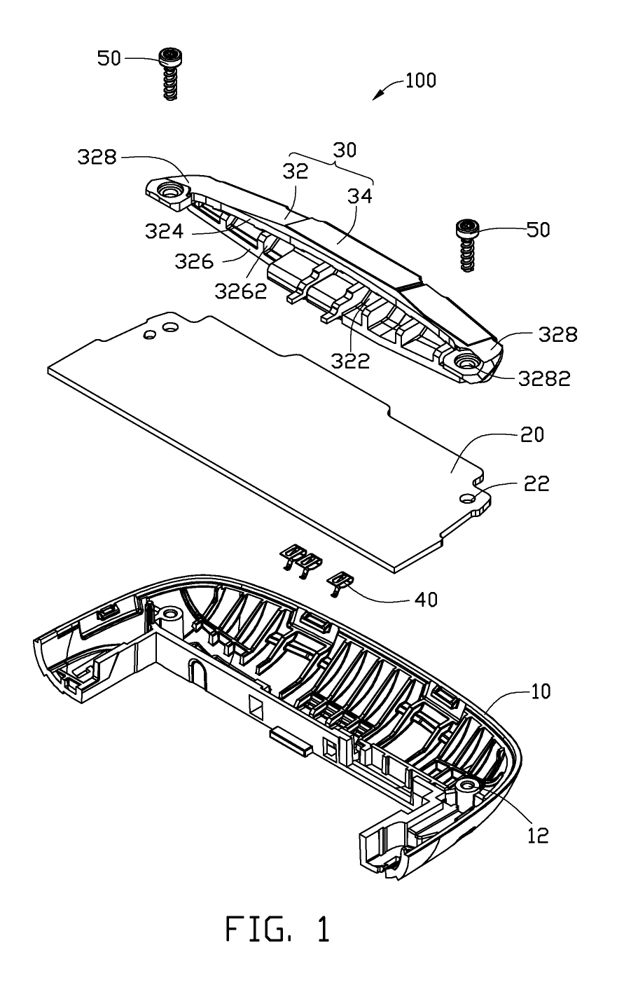

FIG. 1 shows an exploded view of a portable electronic device 100 according to an exemplary embodiment of the disclosure. The portable electronic device 100 can be a mobile phone or a personal digital assistant, and the mobile phone is taken here as an example to illustrate the disclosure.

The mobile phone 100 includes a housing 10, a circuit board 20, an antenna module 30, a plurality of elastic contacts 40, and a plurality of fasteners, such as screws 50. In this exemplary embodiment, the housing 10 can be a part of cover of the mobile phone 100 and defines a plurality of screw holes 12 corresponding to the screws 50. The screws 50 are screwed into the screw holes 12, respectively.

The circuit board 20 can be a motherboard of the mobile phone 100 and is capable of holding many of the electronic components of the mobile phone 100, while providing support and connections for other peripherals. The circuit board 20 defines a plurality of through holes 22, and the screws 50 extend through the corresponding through holes 22 to reach the screw holes 12.

The elastic contacts 40 can be made from copper, steel, or other metal material. In this exemplary embodiment, the circuit board 20 and the antenna module 30 are fixed and assembled to the housing 10 with screws 50. The elastic contacts 40 are fixedly assembled to contacts of the circuit board 20 and non-fixedly electrically connected to the antenna module 30.

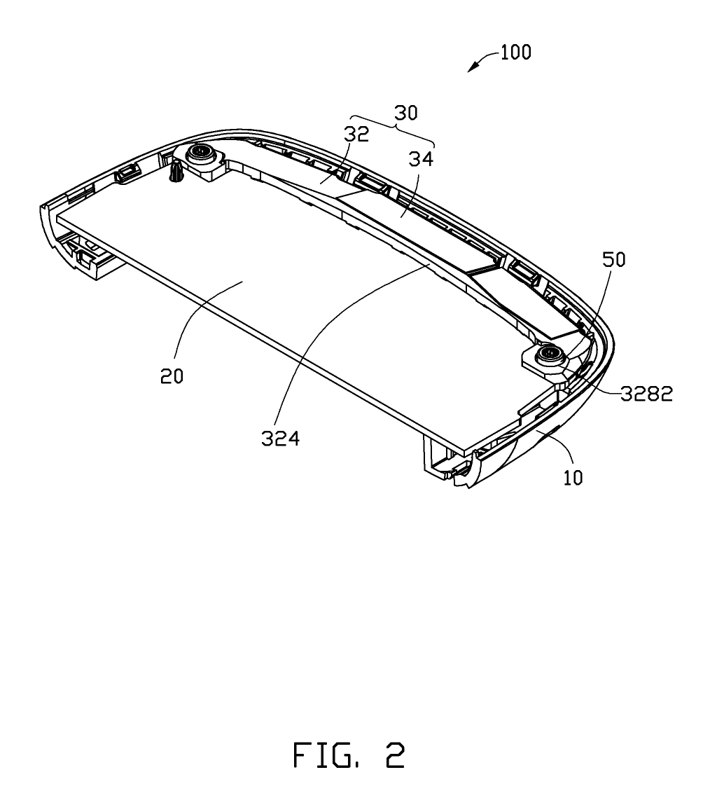

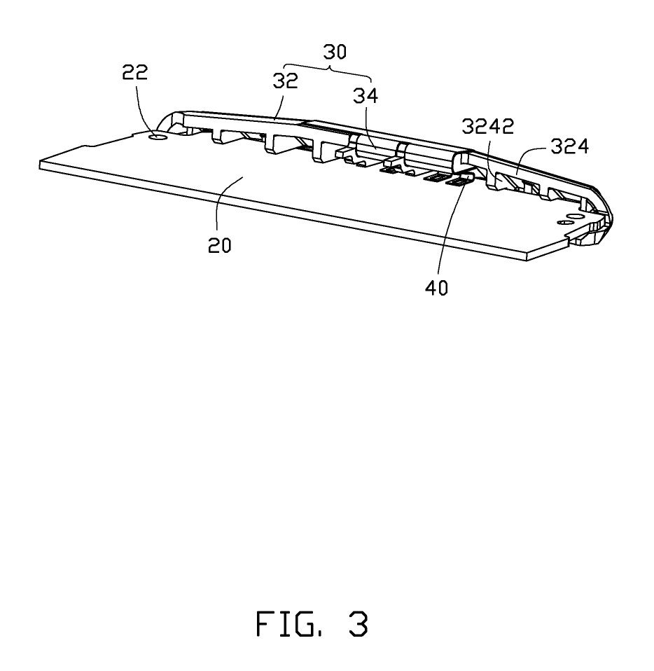

Further referring to FIGS. 2 and 3, the antenna module 30 includes a base body 32 and an antenna 34. The base body 32 includes two opposite end walls 328, a first sidewall 324, and a second sidewall 326. The base body 32 defines a receiving space 322 near the middle of the base body 32, and the receiving space 322 is surrounded by the two opposite end walls 328, the first sidewall 324, and the second sidewall 326. The receiving space 322 is capable of receiving one part of the circuit board 20.

The first sidewall 324 includes a plurality of first positioning portions 3242 protruding toward the second sidewall 326, and the second sidewall 326 includes a plurality of second positioning portions 3262 protruding toward the first sidewall 324. Hence, when one end of the circuit board 20 is partially received within the receiving space 322, the circuit board 20 is fixed and is held by the first positioning portions 3242 and the second positioning portions 3262. Each end wall 328 defines a mounting hole 3282 for extension of the corresponding screw 50 therethrough.

Also referring to FIGS. 1, 2 and 3, in assembly, the antenna 34 is assembled to the base body 32, the elastic contacts 40 are fixed to contact pads on the circuit board 20 by such at least partially permanent means as soldering. One end of the circuit board 20 is partially inserted and is received within the receiving space 322 of the base board 32, and the circuit board 20 is detachably fixed and is held by the first positioning portions 3242 and the second positioning portions 3262. Hence, the elastic contacts 40 resist against contacts of the antenna 34, resulting in placing the circuit board 20 in electronic communication with the antenna 34 without fixedly connecting the antenna 34 to the circuit board 20. The mounting holes 3282 of the end walls 328 are aligned with the through holes 22 of the circuit board 20, respectively. The circuit board 20 and the antenna module 30 are assembled to the housing 10, and the mounting holes 3282 and the through holes 22 are aligned with the corresponding screw holes 12 of the housing 10. The screws 50 then extend through the corresponding mounting holes 3282, the through holes 22, and are screwed into the screw holes 12 in turn. Thus, the antenna module 30 is detachably assembled to the housing 10.

In this exemplary embodiment, there are two each of the holes 12, 22, 3282, and the screws 50.

In summary, in the mobile phone 100 of the exemplary embodiment of this disclosure, the antenna module 30, the circuit board 20 and the housing 10 are detachably assembled together, which has the advantages of easy assembly. Additionally, the antenna module 30 can be easily disassembled from the housing 10 and replaced or repaired, because of the use of the screws 50 and the elastic contacts 40, instead of an at least partially permanent method, such as surface mount technology.

In the present specification and claims the word “a” or “an” preceding an element does not exclude the presence of a plurality of such elements. Further, the word “comprising” does not exclude the presence of other elements or steps than those listed.

It is to be understood, however, that even though numerous characteristics and advantages of the exemplary disclosure have been set forth in the foregoing description, together with details of the structure and function of the exemplary disclosure, the disclosure is illustrative only, and changes may be made in detail, especially in matters of shape, size, and arrangement of parts within the principles of exemplary disclosure to the full extent indicated by the broad general meaning of the terms in which the appended claims are expressed.

What is claimed is:

1. An antenna module electrically connected to a circuit board of a portable electronic device, the antenna module comprising:
a base body defining a receiving space formed near the middle of the base body and mounting holes at opposite ends of the base body, the mounting holes for receiving fasteners; and
an antenna fixed on the base body, wherein one end of the circuit board is partially received within the receiving space, the antenna non-fixedly electrically connected to the circuit board, the fasteners extend through the corresponding mounting holes, and the base body and the circuit board are detachably assembled to a housing of the portable electronic device together.

2. The antenna module as claimed in claim 1, wherein the base body comprises two opposite end walls, a first sidewall and a second sidewall, the receiving space are surrounded by the end walls, the first sidewall and the second sidewall cooperatively, and the first sidewall and the second sidewall are spaced by the receiving space.

3. The antenna module as claimed in claim 2, wherein the first sidewall comprises a plurality of first positioning portions protruding toward the second sidewall, the second sidewall comprises a plurality of second positioning portions protruding toward the first sidewall, and when one end of the circuit board is partially received within the receiving space, the circuit board is fixed and is held by the first positioning portions and the second positioning portions, cooperatively.

4. The antenna module as claimed in claim 1, wherein the fasteners are two screws screwed into the corresponding mounting holes.

5. An antenna module assembled to a housing of a portable electronic device, the portable electronic device further comprising a circuit board and fasteners, the antenna module comprising:
a base body defining mounting holes; and
an antenna fixed on the base body, wherein the circuit board defines through holes corresponding to the mounting holes, the fasteners extend through the corresponding mounting holes, and are screwed into the through holes in turn, the base body and the circuit board are detachably assembled to each other and the housing together, and the circuit board is non-fixedly electrically connected to the antenna.

6. The antenna module as claimed in claim 5, wherein the base body comprise two opposite end walls, a first sidewall and a second sidewall, and the base body defines a receiving space near the middle of the base body and surrounded by the end walls, the first sidewall and the second sidewall cooperatively, and the first sidewall and the second sidewall are spaced by the receiving space.

7. The antenna module as claimed in claim 6, wherein the first sidewall comprises a plurality of first positioning portions protruding toward the second sidewall, the second sidewall comprises a plurality of second positioning portions protruding toward the first sidewall, and when one end of the circuit board is partially received within the receiving space, the circuit board is fixed and is held by the first positioning portions and the second positioning portions, cooperatively.

8. The antenna module as claimed in claim 5, wherein the fasteners are two screws corresponding to the through holes and the mounting holes.

9. A portable electronic device, comprising:
a housing;
a circuit board detachably received within the housing, the circuit board defining a plurality of through holes;
a plurality of fasteners corresponding to the through holes; and
an antenna module non-fixedly electrically connected to the circuit board, the antenna module comprising:
a base body defining mounting holes; and
an antenna located on the base body, wherein the fasteners are inserted and extend through the corresponding mounting holes and the through holes in turn, and are screwed in the housing, the base body and the circuit board are detachably assembled to each other and the housing together, and the circuit board is non-fixed electrically connected to the antenna.

10. The portable electronic device as claimed in claim 9, wherein the base body comprise two opposite end walls, a first sidewall and a second sidewall, and the base body defines a receiving space near the middle of the base body and surrounded by the end walls, the first sidewall and the second sidewall cooperatively, and the first sidewall and the second sidewall are spaced by the receiving space.

11. The portable electronic device as claimed in claim 10, wherein the first sidewall comprises a plurality of first positioning portions protruding toward the second sidewall, the second sidewall comprises a plurality of second positioning portions protruding toward the first sidewall, and when one end of the circuit board is partially received within the receiving space, the circuit board is fixed and is held by the first positioning portions and the second positioning portions, cooperatively.

12. The portable electronic device as claimed in claim 9, wherein the housing defines a plurality of screw holes corresponding to the screws, the mounting holes and the through holes, the screws extend through the corresponding mounting holes and the through holes, and are screwed into the screw holes in turn, and the antenna module is detachably assembled to the housing.

13. The portable electronic device as claimed in claim 12, wherein the antenna module is replaced and is disassembled from the housing by rotating and moving the fasteners from the corresponding screw holes.

14. The portable electronic device as claimed in claim 9, further comprising a plurality of elastic contacts, wherein the elastic contacts are assembled to the circuit board and are electrically connected to the antenna module.

15. The portable electronic device as claimed in claim 9, wherein the fasteners are a plurality of screws corresponding to the mounting holes and the through holes.
